(19) United States
(12) Patent Application Publication
(10) Pub. No.: US 2011/0030698 A1
(43) Pub. Date: Feb. 10, 2011

(54) MRI COMPATIBLE KNEE POSITIONING DEVICE

(76) Inventors: Kenton R. Kaufman, Rochester, MN (US); Kimberly K. Amrami, Rochester, MN (US); Matthew F. Koff, Livingston, NJ (US); Fredrick Schultz, Rochester, MN (US)

Correspondence Address: QUARLES & BRADY LLP, 411 E. WISCONSIN AVENUE, SUITE 2040, MILWAUKEE, WI, 53202-4497, US

(21) Appl. No.: 12/851,018

(22) Filed: Aug. 5, 2010

Related U.S. Application Data
(60) Provisional application No. 61/231,940, filed on Aug. 6, 2009.

(51) Int. Cl. A61G 15/00

(52) U.S. Cl. 128/845

(57) ABSTRACT

A device for positioning a subject's knee during an MRI scan. The device includes foot, knee, and thigh positioning apparatuses. Each of the positioning apparatuses can be translated and/or rotated to allow correct and consistent position of the subject's knee within the MRI magnetic bore. The device includes a user control to facilitate repeat measurements of knee characteristics with reduced intra- and inter-technologist variability.

### CROSS REFERENCE TO RELATED APPLICATIONS

This application is based on, claims the priority of, and incorporates herein by reference U.S. Provisional Application Ser. No. 61/231,940, entitled “MRI Compatible Knee Positioning Device,” filed Aug. 6, 2009.

### STATEMENT REGARDING FEDERALLY SPONSORED RESEARCH

This invention was made with government support under Grant No. NIAMS R01AR048768 (KRK, KKA) and F32AR053430-01 (MFK). The United States Government has certain rights in this invention.

### BACKGROUND

Implementations generally relate to methods and devices for medical imaging and, more particularly, methods and devices for magnetic resonance imaging of joints.

In a magnetic resonance imaging (MRI) system, when a substance such as human tissue is subjected to a uniform magnetic field (polarizing field B₀), the individual magnetic moments of the excited nuclei in the tissue attempt to align with this polarizing field, but precess about it in random order at their characteristic Larmor frequency. If the substance, or tissue, is subjected to a magnetic field (excitation field B₁) that is in the x-y plane and that is near the Larmor frequency, the net aligned moment, M_{z}, may be rotated, or “tipped”, into the x-y plane to produce a net transverse magnetic moment Mₜ. A signal is emitted by the excited nuclei or “spins”, after the excitation signal B₁ is terminated, and this signal may be received and processed to form an image.

In MRI systems, the excited spins induce an oscillating sine wave signal in a receiving coil. The frequency of this signal is near the Larmor frequency, and its initial amplitude, A₀, is determined by the magnitude of the transverse magnetic moment Mₜ. The amplitude, A, of the emitted NMR signal decays in an exponential fashion with time, t. The decay constant 1/T2* depends on the homogeneity of the magnetic field and on T₂, which is referred to as the “spin-spin relaxation” constant, or the “transverse relaxation” constant. The T₂ constant is inversely proportional to the exponential rate at which the aligned precession of the spins would dephase after removal of the excitation signal B₁ in a perfectly homogeneous field. The practical value of the T₂ constant is that tissues have different T₂ values and this can be exploited as a means of enhancing the contrast between such tissues.

Another important factor that contributes to the amplitude A of the NMR signal is referred to as the spin-lattice relaxation process that is characterized by the time constant T₁. It describes the recovery of the net magnetic moment M to its equilibrium value along the axis of magnetic polarization (z). The T₁ time constant is longer than T₂, much longer in most substances of medical interest. As with the T₂ constant, the difference in T₁ between tissues can be exploited to provide image contrast.

When utilizing these “MR” signals to produce images, magnetic field gradients (Gₓ, G_{y} and G_{z}) are employed. Typically, the region to be imaged is scanned by a sequence of measurement cycles in which these gradients vary according to the particular localization method being used. The resulting set of received MR signals are digitized and processed to reconstruct the image using one of many well known reconstruction techniques.

Many patients suffer from knee disorders such as tumors or osteoarthritis. Osteoarthritis (OA), for example, is a degenerative disease of articular cartilage that afflicts more than 21 million people and is a leading cause of disability for adults in the US. OA decreases the load bearing capabilities of tissue and leads to impaired joints. MRI is a powerful tool for non-invasively evaluating OA and joint pathology in-vivo. MRI studies of diarthrodial joints can evaluate qualitative measures of OA within a joint. Examples of quantitative measures include minimum joint space width (JSW), cartilage volume, cartilage thickness, cartilage T₂ values, and T₁ values of cartilage in the presence of the contrast agent GD-DTPA. However, it is difficult to measure joint changes over time using these techniques due to variations in subject positioning and image slice definition. This is especially problematic for the knee, which can be difficult for technologists to consistently position for different MRI scans.

It would therefore be desirable to have a system and method to reduce intra- and inter-technologist variability between scans and allow consistent quantitative measurement of a characteristic of the knee.

### SUMMARY

A knee positioning device allows quantitative measurements of knee characteristics to be repeated with consistency. This consistency in repeated measurements can reduce both intra- and inter-technologist variability.

In one implementation a device is used to position the knee of a subject for an MRI scan. The device includes a local coil apparatus configured to position a knee of a subject, a thigh support proximal to a first end of the local coil apparatus, a foot positioning apparatus proximal to a second end of the local coil apparatus, and a user control. The thigh support apparatus has an adjustable medial thigh support and adjustable lateral thigh support configured to position the subject's thigh. The foot support is configured to position a foot of the subject within a foot positioning apparatus. The user control is configured to position each of the foot positioning apparatus, the thigh positioning apparatus, and the local coil apparatus to allow repeated quantitative measurements of a property of the knee.

In another implementation, a device is used to position a knee of a subject for a Magnetic Resonance Imaging (MRI) scan. The device includes a MRI local coil apparatus and a leg stabilizer. The leg stabilizer is configured to position a thigh joint and an ankle joint of a leg of a subject to a predetermined configuration to allow repeated quantitative measurements of a property of the knee.

In yet another implementation, repeated quantitative measurements of a property of a knee of a subject are conducted. The knee is positioned with a MRI local coil apparatus, the thigh is positioned with an adjustable medial thigh support and an adjustable lateral thigh support each coupled to the MRI local coil apparatus, and the foot is positioned with a foot positioning apparatus that is also coupled to the MRI local coil apparatus. At least one parameter is recorded that is usable to reposition each of: the thigh with the adjustable medial and lateral thigh supports; the knee with the MRI local coil; and the foot with the MRI local coil apparatus.

### BRIEF DESCRIPTION OF THE DRAWINGS

Implementations will become more apparent from the detailed description set forth below when taken in conjunction with the drawings, in which like elements bear like reference numerals.

FIG. 1 is a block diagram of an MRI system designed to be used with the present invention;

FIG. 2 is a block diagram of an RF system that forms part of the MRI system of FIG. 1;

FIG. 3 is a depiction of a knee positioning device in accordance with the present invention; and

FIG. 4 is a flow diagram for repeatedly analyzing joint anatomy using the knee positioning device depicted in FIG. 3.

### DETAILED DESCRIPTION

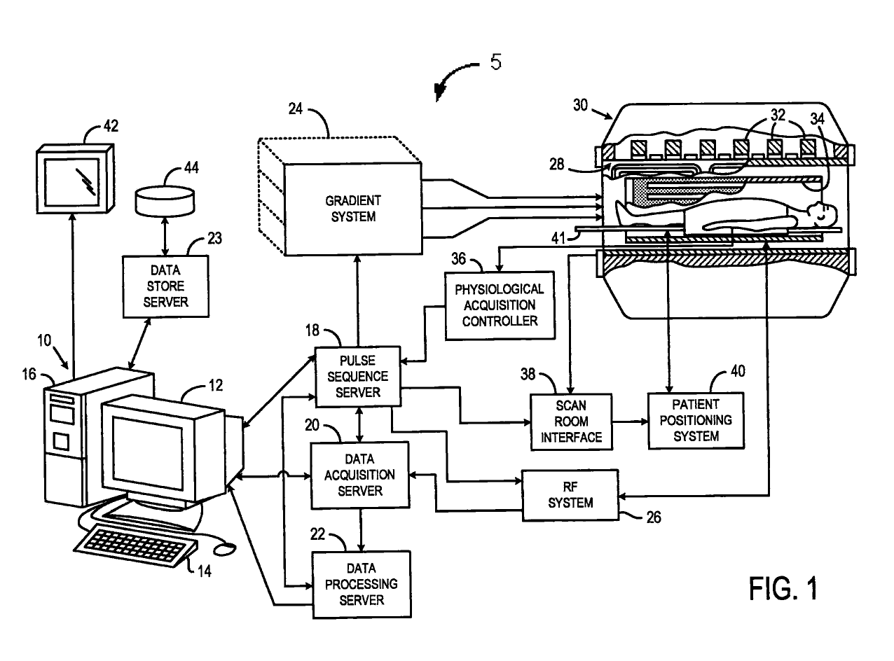

Referring to FIG. 1, an MRI system 5 is illustrated. The MRI system 5 includes a workstation 10 having a display 12 and a keyboard 14. The workstation 10 includes a processor 16 that is a commercially available programmable machine running a commercially available operating system. The workstation 10 provides the operator interface that enables scan prescriptions to be entered into the MRI system 5. The workstation 10 is coupled to four servers including a pulse sequence server 18, a data acquisition server 20, a data processing server 22, and a data store server 23. The workstation 10 and each server 18, 20, 22 and 23 are connected to communicate with each other.

The pulse sequence server 18 functions in response to instructions downloaded from the workstation 10 to operate a gradient system 24 and an RF system 26. Gradient waveforms necessary to perform the prescribed scan are produced and applied to the gradient system 24 that excites gradient coils in an assembly 28 to produce the magnetic field gradients Gₓ, G_{y} and G_{z} used for position encoding MR signals. The gradient coil assembly 28 forms part of a magnet assembly 30 that includes a polarizing magnet 32 and a whole-body RF coil 34.

RF excitation waveforms are applied to the RF coil 34 by the RF system 26 to perform the prescribed magnetic resonance pulse sequence. Responsive MR signals detected by the RF coil 34 or a separate local coil (not shown in FIG. 1) are received by the RF system 26, amplified, demodulated, filtered, and digitized under direction of commands produced by the pulse sequence server 18. The RF system 26 includes an RF transmitter for producing a wide variety of RF pulses used in MR pulse sequences. The RF transmitter is responsive to the scan prescription and direction from the pulse sequence server 18 to produce RF pulses of the desired frequency, phase and pulse amplitude waveform. The generated RF pulses may be applied to the whole body RF coil 34 or to one or more local coils or coil arrays (not shown in FIG. 1).

The RF system 26 also includes one or more RF receiver channels. Each RF receiver channel includes an RF amplifier that amplifies the MR signal received by the coil to which it is connected and a detector that detects and digitizes the I and Q quadrature components of the received MR signal. The magnitude of the received MR signal may thus be determined at any sampled point by the square root of the sum of the squares of the I and Q components:

M=\sqrt{I²+Q²},

and the phase of the received MR signal may also be determined:

φ=tan⁻¹Q/I.

The pulse sequence server 18 also optionally receives patient or subject data from a physiological acquisition controller 36. The controller 36 receives signals from a number of different sensors connected to the patient, such as ECG signals from electrodes or respiratory signals from a bellows. Such signals are typically used by the pulse sequence server 18 to synchronize, or “gate”, the performance of the scan with the subject's respiration or heart beat.

The pulse sequence server 18 also connects to a scan room interface circuit 38 that receives signals from various sensors associated with the condition of the patient and the magnet system. It is also through the scan room interface circuit 38 that a patient positioning system 40 receives commands to move the patient to desired positions during the scan by translating the patient table 41.

The digitized MR signal samples produced by the RF system 26 are received by the data acquisition server 20. The data acquisition server 20 operates in response to instructions downloaded from the workstation 10 to receive the real-time MR data and provide buffer storage such that no data is lost by data overrun. In some scans the data acquisition server 20 does little more than pass the acquired MR data to the data processor server 22. However, in scans that require information derived from acquired MR data to control the further performance of the scan, the data acquisition server 20 is programmed to produce such information and convey it to the pulse sequence server 18. For example, during prescans, MR data is acquired and used to calibrate the pulse sequence performed by the pulse sequence server 18. Also, navigator signals may be acquired during a scan and used to adjust RF or gradient system operating parameters or to control the view order in which k-space is sampled. And, the data acquisition server 20 may be employed to process MR signals used to detect the arrival of contrast agent in an MRA scan. In all these examples the data acquisition server 20 acquires MR data and processes it in real-time to produce information that is used to control the scan.

The data processing server 22 receives MR data from the data acquisition server 20 and processes it in accordance with instructions downloaded from the workstation 10. Such processing may include, for example, Fourier transformation of raw k-space MR data to produce two or three-dimensional images, the application of filters to a reconstructed image, the performance of a backprojection image reconstruction of acquired MR data; the calculation of functional MR images, the calculation of motion or flow images, and the like.

Images reconstructed by the data processing server 22 are conveyed back to the workstation 10 where they are stored. Real-time images are stored in a data base memory cache (not shown) from which they may be output to operator display 12 or a display 42 that is located near the magnet assembly 30 for use by attending physicians. Batch mode images or selected real time images are stored in a host database on disc storage 44. When such images have been reconstructed and transferred to storage, the data processing server 22 notifies the data store server 23 on the workstation 10. The workstation 10 may be used by an operator to archive the images, produce films, or send the images via a network to other facilities.

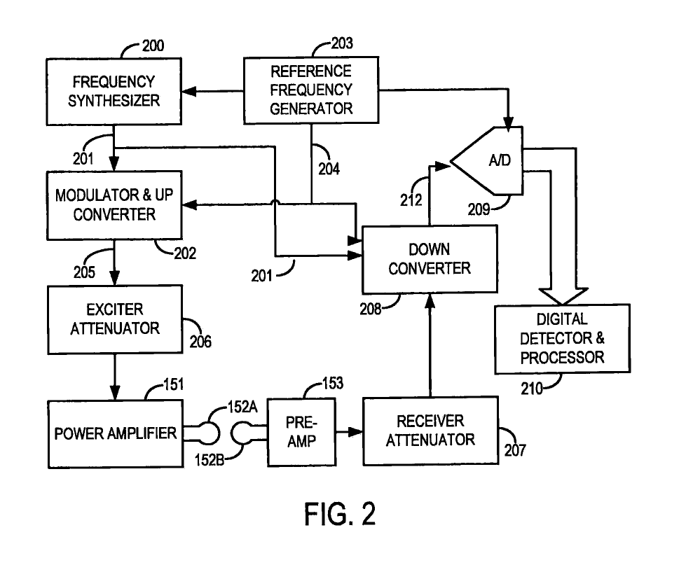

As shown in FIG. 1, the RF system 26 may be connected to the whole body RF coil 34, or as shown in FIG. 2, a transmitter section of the RF system 26 may connect to one RF coil 152A and its receiver section may connect to a separate RF receive coil 152B. Often, the transmitter section is connected to the whole body RF coil 34 and each receiver section is connected to a separate local coil 152B.

Referring particularly to FIG. 2, the RF system 26 includes a transmitter that produces a prescribed RF excitation field. The base, or carrier, frequency of this RF excitation field is produced under control of a frequency synthesizer 200 that receives a set of digital signals from the pulse sequence server 18. These digital signals indicate the frequency and phase of the RF carrier signal produced at an output 201. The RF carrier is applied to a modulator and up converter 202 where its amplitude is modulated in response to a signal R(t) also received from the pulse sequence server 18. The signal R(t) defines the envelope of the RF excitation pulse to be produced and is produced by sequentially reading out a series of stored digital values. These stored digital values may, be changed to enable any desired RF pulse envelope to be produced.

The magnitude of the RF excitation pulse produced at output 205 is attenuated by an exciter attenuator circuit 206 that receives a digital command from the pulse sequence server 18. The attenuated RF excitation pulses are applied to the power amplifier 151 that drives the RF coil 152A.

Referring still to FIG. 2 the signal produced by the subject is picked up by the receiver coil 152B and applied through a preamplifier 153 to the input of a receiver attenuator 207. The receiver attenuator 207 further amplifies the signal by an amount determined by a digital attenuation signal received from the pulse sequence server 18. The received signal is at or around the Larmor frequency, and this high frequency signal is down converted in a two step process by a down converter 208 that first mixes the MR signal with the carrier signal on line 201 and then mixes the resulting difference signal with a reference signal on line 204. The down converted MR signal is applied to the input of an analog-to-digital (A/D) converter 209 that samples and digitizes the analog signal and applies it to a digital detector and signal processor 210 that produces 16-bit in-phase (I) values and 16-bit quadrature (Q) values corresponding to the received signal. The resulting stream of digitized I and Q values of the received signal are output to the data acquisition server 20. The reference signal as well as the sampling signal applied to the A/D converter 209 are produced by a reference frequency generator 203.

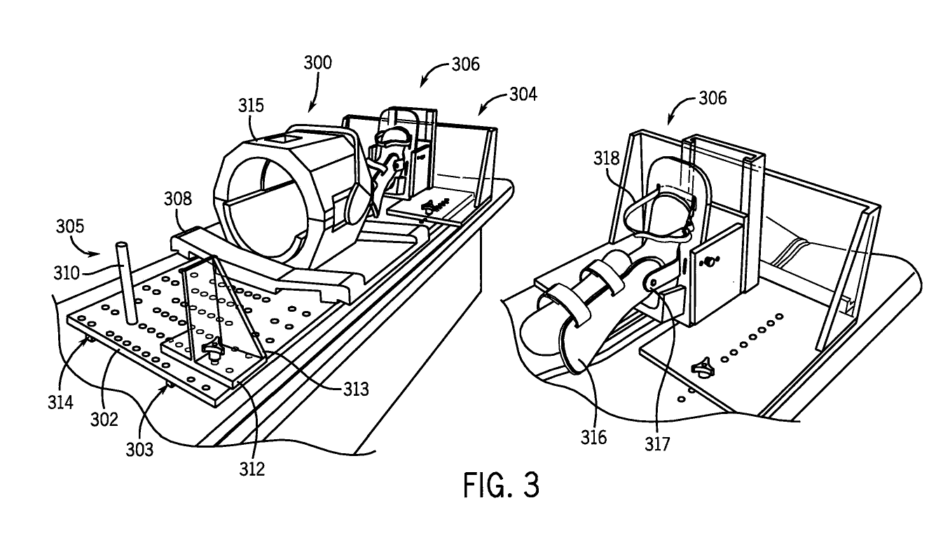

Referring to FIG. 3, a knee positioning device for reducing the effect of intra- and inter-technologist variation on quantitative imaging scan measurements, such as MRI measurements, of joint anatomy is depicted. In one implementation, a quantitative MRI measurement relates to OA in a human, such as an infant or elderly person, or an animal (collectively “subject”). The device 300 may include a support platform 302 that is configured to extend lengthwise from a proximal end 303 through the bore of an MRI system 5, such as described above with respect to FIG. 1, to a distal end 304. The support platform is typically disposed on top of the MRI patient table 41 of FIG. 1 and its dimensions can be chosen accordingly. For example, the device may be approximately 5 ft long and 14 in wide to match the width of the MRI patient table 41 of FIG. 1 and allow passage through the MRI magnetic bore. Mounted towards the proximal end 303 of the support platform 302 is a thigh positioning apparatus, such as a thigh positioning device 305, which is configured to secure a subject's thigh. A foot positioning apparatus, such as a foot positioning device 306 is mounted towards the distal end 304 of the support platform 302 and a knee positioning apparatus, such as a knee positioning device 308, is mounted to the support platform 302 between the thigh and foot positioning devices 305 and 306, respectively.

The thigh positioning device 305 is configured to position a subject's thigh and includes a medial support 310 and lateral support 312, which are positioned at opposite ends of the support table's width and together confine the thigh in the intervening space therebetween. Thus, medial support 310 and lateral support 312 are configured to constrain subject motion in the medial/lateral direction. It is contemplated that the medial support 310 is cylindrical and extends in an anterior direction upwards from the plane of the support platform 302. The lateral support 312 may be substantially planar, extending lengthwise in anterior direction and buttressed by a secondary support 313 to prevent distortion in the plane parallel to the support platform 302. Both of these supports, may for example, utilize a peg-board of holes drilled into the support platform 302, which may be made of Plexiglas materials for example, to enable the repositioning and adjustment of the thigh positioning device 305 according to subject size. The knee positioning device 308 is configured to mount an MRI local coil apparatus, such as a MRI knee coil 315, by having a surface shaped to firmly envelop the underside of the knee coil 315. The tightness of fit of the knee coil 315 to this surface, in combination with the weight of the subject's knee, helps ensure that the knee is fixed in a selected location and will not move significantly during scanning.

The foot positioning device 306 includes an ankle foot orthosis 316 having a hinge 317 and a toe strap 318 to secure the subject's foot. The components of the foot positioning device 306 can be moved to provide incremental changes in the anterior/posterior (transverse plane), medial/lateral (coronal plane), and superior/inferior (sagittal plane) positions of the patient's foot. The hinge 317 allows incremental changes of foot rotation in the dorsal/plantar and inversion/eversion directions. Accordingly, the subject's foot may be moved (e.g., translated and/or rotated) to position the knee in a desired pose at the magnetic iso-center of the magnet. Remaining degrees of freedom of the device 300 can be individually positioned to a given subject's comfort. The thigh positioning apparatus and foot positioning apparatus may collectively be referred herein as a “leg stabilizer.”

A health care provider, such as a clinician, may employ the above-described device and process to perform consistent repeat measurements of joint characteristics to, for example, evaluate quantitative changes of joint anatomy or pathology over time. In one implementation, the device 300 is used to evaluate pathology such as tumors or knee OA. Other uses of the device 300 are also contemplated such as repeat measurements of joint anatomy to evaluate the structural integrity or health of the underlying imaged tissues. Each measurement typically begins with the positioning of a subject within the device 300, wherein the position and angle of the device components are adjusted based on the subject size and imaging task or to conform to settings used for a previous scan. To quantitatively measure minimum JSW in the patello-femoral joint or the tibio-femoral joint, for example, the subject's thigh may be positioned in the thigh positioning device 305 and secured firmly between the medial thigh support 310 and the lateral thigh support 312. The subject's leg can be positioned so that the knee rests on the bottom portion of and through the knee coil 315, which rests firmly within the knee positioning device 308, and the foot is secured in the foot positioning device 306. The top portion of the knee coil 315 can then be secured to the bottom of the knee coil 315 and the positioning devices can then be individually translated and/or rotated to position the subject's knee within the “sweet spot” of the MRI bore. Slice profiles can then be defined along an axis-of-interest, for example, along the line connecting the most posterior aspect of the medial and lateral femoral condyles seen in scout images, where the central most slice is positioned through the widest portion of the patella. An MRI can then be performed to obtain a plurality of image slices, which can subsequently be analyzed by the clinician to determine the minimum JSW. By repeating such scans over time using similar position and rotation settings for the knee positioning device 300, the clinician can observe changes in minimum JSW that may be indicative of OA. Since JSW measurement variability between scans is reduced via the use of the knee positioning device 300, the accuracy of the clinician's observations may increase significantly.

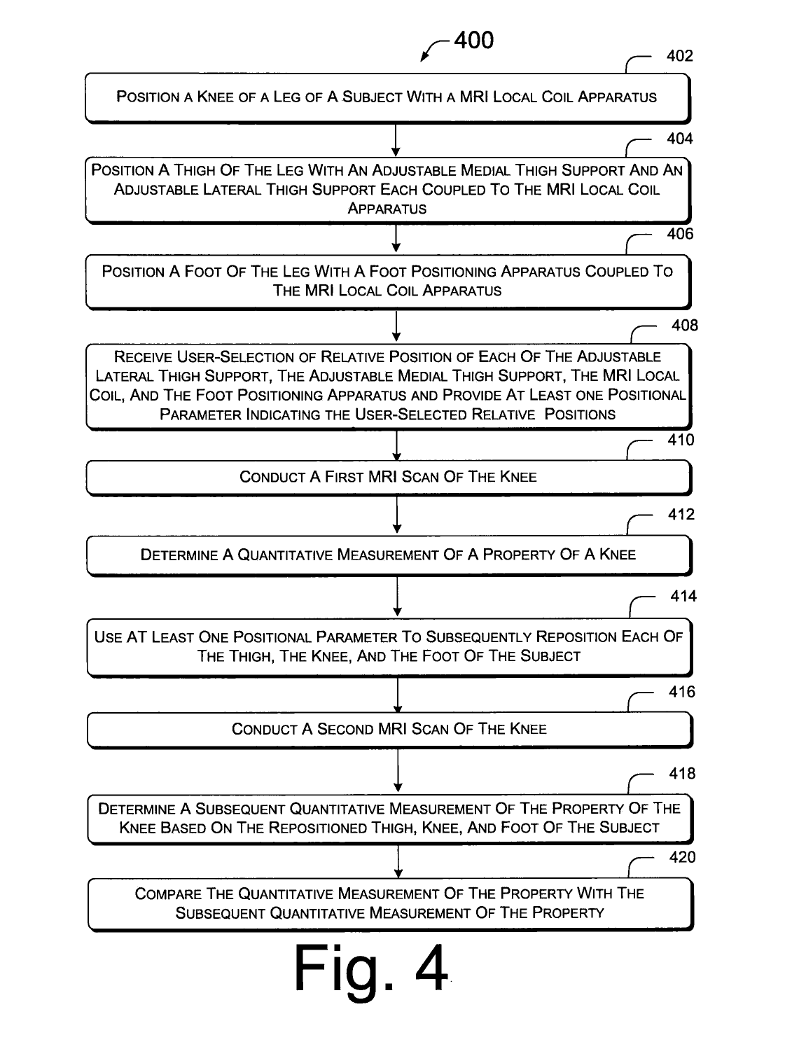

Referring to FIG. 4, a flow diagram depicts a process 400 for conducting repeated quantitative measurements of a property of a knee using the device 300 of FIG. 3. At step 402, the knee of a leg of the subject is positioned with a MRI local coil apparatus. For example, the subject may lie in a supine position on the MRI tray with the knee located in the bottom half of a dedicated transmit-receive MRI local coil. The subject may shift proximally or distally to ensure that the center of the knee is at the center of the MRI local coil. The top portion of the MRI local coil is then secured to the bottom portion. Padding around the knee within the MRI local coil can be used to control potential motion. At step 404, the thigh of the same leg is positioned with the adjustable medial thigh support and the adjustable lateral thigh support described above. At step 406, the foot of the same leg is positioned with the foot positioning apparatus described above.

In some implementations, the positioning of the knee, thigh, and foot are done manually by a technician, for example. In other implementations, the positioning is done automatically with a mechanical device that is controlled by a processor executing a computer program. For example, the executed program may drive motors and gears that position each of the knee, joint, and foot in a predefined configuration.

At step 408, a user control receives a user-selection of a relative position of at least one of the foot positioning apparatus, the MRI local coil, and the thigh positioning apparatus. For example, in the example above, the user control may receive a location of the pegs in the plane of the peg-board for each of the lateral support 312 and the medial support 310 of the thigh positioning device 305 from a user. Similarly, the user control may receive each of the angles of the knee joint positioned in the MRI local coil apparatus and the ankle joint positioned in the ankle foot orthosis. Further at step 408, the user control provides an at least one positional parameter indicating the user-selected, relative position of each of the foot positioning apparatus and the thigh positioning apparatus, designed to facilitate repeated quantitative measurements of a property of the knee across a plurality of medical imaging scans. In the peg-board example above, the user control may provide an indication of location of the pegs when the subject is positioned in the leg stabilizer. In one implementation, the indication may be recorded and stored in a database or displayed via a user interface. For example, in the automated implementations described above, information about the amount of revolutions of the each of the motors that produced the configuration of the leg, for example, may be electronically recorded and stored in a database.

A first MRI scan is taken including at least one MRI image of the knee at step 410. The subject may be scanned in a relaxed state, such that muscle contraction is negligible. Alternatively, the subject may be scanned while at least some of the muscles of the leg are under isometric contraction. The subject, or the technician, then removes the leg from the knee positioning device 300.

At step 412, a quantitative measurement of a property of the knee is determined. In one implementation, the property of the knee is JSW determined using an algorithm. A processor executes a computer program that utilize data obtained from the MRI scan. For example, the executed program may receive as input a series of oblique, sagittal, spiral, fast spoiled gradient recalled (SPGR) images with frequency selective fat suppression. The executed program assigns each pixel in the images a value based on the ratio of signal intensity differences in the local 8-pixel neighborhood to maximal signal intensity differences in the image. Next, the user of the program defines a seed point to initialize the program to search for the cartilage-bone interface. This seed point is placed on the anterior or posterior margins of the femur and tibia for calculating tibio-femoral JSW or on the proximal or distal margin of the patella and corresponding region on the femur for calculating patello-femoral JSW, for example. The program then performs a semi-automated line search on the image, starting at the seed point and follows along a calculated path of maximal signal intensity differences to determine the edges of the joint space, from which the minimum JSW is calculated. In another implementation, the property of the knee may be cartilage volume, cartilage thickness, cartilage T₂ values, or T1 values of cartilage in the presence of the contrast agent, such as gadolinium diethylenetriamine penta-acetic acid (Gd-DTPA), that employ 2D or 3D MRI images.

At step 414, the thigh, the knee, and the foot of the subject are repositioned using the parameter recorded at step 408. For example, the subject may return for a second scan a month after the first scan. The leg of the subject is repositioned to its previous configuration, repeating steps 402 through 406 in process 400. To illustrate, the pegs in the peg board may be repositioned to their previous location such that the lateral support 312 and the medial support 310 of the thigh positioning device 305 are identical or about identical to their previous respective positions. Similarly, the knee angle may be repositioned with the MRI local coil and the foot angle may be repositioned with the foot positioning apparatus.

At step 416, a second, subsequent MRI scan of the knee is taken of the leg that has been repositioned in step 414. At step 418, a subsequent quantitative measurement of the property of the knee is determined based on the repositioned thigh, knee, and foot. For example, the JSW may be recalculated using a similar method described in step 412. Here, however, the executed program may receive as input a series of SPGR images taken of the repositioned leg.

At step 420, the quantitative measurement of the property of the knee is compared with the subsequent quantitative measurement of the property. For example, the JSW determined for the initially positioned leg is compared to the JSW determined for the subsequently repositioned leg. The result of the comparison may be usable in a diagnosis. For example, if the JSW has significantly changed in the one month span between the first MRI scan and the second MRI scan, then the OA of the patient may have caused degeneration of the knee joint.

Thus, implementations provide multiple advantages over prior devices for positioning the knee within an MRI system 5. That is, prior devices were generally designed for kinematic studies in which the knee is intentionally moved during or between scans, for example, to study patellar tracking abnormalities or the real-time motion of the patella during knee flexion and extension. Prior knee positioning devices were designed to reduce subject motion during the scan, as some MRI acquisition sequences are sensitive to motion. However, these devices were not designed to secure the knee in a consistent position throughout a series of different scans that are potentially performed by different technologists. Consequently, these prior devices do not lead to a reduction in scan variability and are unsuitable for situations in which repeated quantitative measurements of a characteristic of the knee, such as minimum JSW, are desired.

It should be understood that implementations can be implemented in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement various implementations.

It is understood that the examples and implementations described herein are for illustrative purposes only and that various modifications, equivalents, alternatives, variations, or changes in light thereof will be suggested to persons skilled in the art and are to be included within the spirit and purview of this application and scope of the appended claims.

What is claimed is:

1. A device for positioning a knee of a subject for a medical imaging scan comprising:
a local coil apparatus extending from a first end to a second end and configured to receive a knee of a subject positioned in an imaging system;
a thigh positioning apparatus arranged proximal to the first end of the local coil apparatus and configured to position a thigh of the subject associated with the knee of the subject with an adjustable medial thigh support and adjustable lateral thigh support;
a foot positioning apparatus arranged proximal to the second end of the local coil apparatus and configured to position a foot of the subject associated with the knee with a foot positioning apparatus;
and
a user control configured to receive a user-selection of a relative position of each of the foot positioning apparatus, the thigh positioning apparatus, and provide an at least one positional parameter indicating the user-selected, relative position of each of the foot positioning apparatus, the thigh positioning apparatus, designed to facilitate repeated quantitative measurements of a property of the knee across a plurality of medical imaging scans.

2. The device as recited in claim 1 wherein the property of the knee is a joint space width.

3. The device as recited in claim 1 wherein the user control includes a pegboard interface configured to provide at least one of the at least one positional parameter.

4. The device as recited in claim 1 wherein the user control is configured to adjust the thigh positioning apparatus, the foot positioning apparatus, and the local coil apparatus individually.

5. The device as recited in claim 4 wherein the at least one position parameter includes at least one of a size of the subject, an imaging task, and settings used in a previous scan of the knee.

6. The device as recited in claim 1 wherein the foot positioning apparatus includes a hinge and is configured to facilitate movement of a corresponding leg of the subject within at least one of a coronal plane, a sagittal plane, and a transverse plane.

7. The device as recited in claim 1 wherein the local coil apparatus is further configured to allow flexion of the knee.

8. A device for positioning a knee of a subject in a Magnetic Resonance Imaging (MRI) system comprising:
a local coil apparatus configured to receive therethrough a knee of a leg of a subject positioned in an MRI system; and
a leg stabilizer configured to receive at least one location parameter and position a thigh joint and an ankle joint of the leg in a predetermined configuration associated with the at least one location parameter for repeated quantitative measurements of a property of the knee using the MRI system.

9. The device as recited in claim 8 wherein the property of the knee is a joint space width.

10. The device as recited in claim 8 wherein the leg stabilizer includes a thigh positioning apparatus and a foot positioning apparatus each capable of individual manipulation to achieve the predetermined configuration.

11. The device as recited in claim 10 wherein the individual manipulation is configured to accommodate on at least one of: a size of the subject, an imaging task, and settings used in a previous MRI scan of the knee.

12. The device as recited in claim 8 wherein the leg stabilizer is further configured to position the knee to a predetermined configuration to allow repeated quantitative measurements of a property of the knee.

13. The device as recited in claim 8 wherein the leg stabilizer allows at least one of the thigh, the knee, and the ankle to move within at least one of a coronal plane, a sagittal plane, and a transverse plane.

14. A method for conducting repeated quantitative measurements of a property of a knee of a subject, the method comprising:
positioning a knee of a leg of the subject within a MRI local coil apparatus;
positioning a thigh of the leg with an adjustable medial thigh support and an adjustable lateral thigh support each coupled to the MRI local coil apparatus;
positioning a foot of the leg with a foot positioning apparatus coupled to the MRI local coil apparatus; and
indicating at least one parameter usable to reposition each of:
the thigh with the adjustable medial thigh support and the adjustable lateral thigh support;
the knee with the MRI local coil apparatus; and
the foot with the foot positioning apparatus.

15. The method as recited in claim 14 further comprising:
conducting a first MRI scan of the knee; and
determining a quantitative measurement of a property of a knee based on the first MRI scan.

16. The method as recited in claim 15, further comprising:
using the at least one parameter to subsequently reposition each of the thigh, the knee, and the foot of the subject;
conducting a second MRI scan of the repositioned knee;
determining a subsequent said quantitative measurement of the property of the knee based on the second MRI scan; and
comparing the quantitative measurement of the property with the subsequent said quantitative measurement of the property.

17. The method as recited in claim 16, wherein a result of the comparing is usable in a diagnosis.

18. The method as recited in claim 15 wherein the property of the knee is a joint space width.

19. The method as recited in claim 15 wherein the property of the knee is selected from the group consisting of cartilage volume, cartilage thickness, a cartilage T2 value, and a cartilage T1 value in the presence of gadolinium.
